(19) United States
(12) Patent Application Publication
(10) Pub. No.: US 2006/0076877 A1
(43) Pub. Date: Apr. 13, 2006

(54) Plasma display panel and plasma display apparatus comprising electrode

(75) Inventor: Woo Tae Kim, Yongin-si (KR)

Correspondence Address: MCKENNA LONG & ALDRIDGE LLP, 1900 K STREET, NW, WASHINGTON, DC, 20006, US

(73) Assignee: LG ELECTRONICS INC., Yongdungpo-gu (KR)

(21) Appl. No.: 11/246,143

(22) Filed: Oct. 11, 2005

(30) Foreign Application Priority Data
Oct. 11, 2004 (KR) 10-2004-0081127
Oct. 11, 2004 (KR) 10-2004-0081128

(51) Int. Cl. H01J 1/62

(52) U.S. Cl. 313/483

(57) ABSTRACT

The present invention relates to a plasma display panel and a plasma display apparatus, and more particularly, to a plasma display panel and plasma display apparatus comprising electrodes. The plasma display panel according to the present invention comprises discharge cell partitioned by barrier ribs, upper electrode part and lower electrode part formed adjacent to the boundary of the discharge cell and applied with a first driving pulse, first center electrode part located between the upper electrode part and the lower electrode part and applied with a second driving pulse, and second center electrode part located between the first center electrode part and the lower electrode part and applied with the second driving pulse. According to the present invention, brightness and discharge efficiency can be improved since a discharge amount is increased and discharge diffusion is easily performed.

### CROSS-REFERENCES TO RELATED APPLICATIONS

This Nonprovisional application claims priority under 35 U.S.C. § 119(a) on Patent Application No. 2004-81127 and 2004-81128 filed in Korea on Oct. 11, 2004 and Oct. 11, 2004 the entire contents of which are hereby incorporated by reference.

### BACKGROUND OF THE INVENTION

1. Field of the Invention

The present invention relates to a plasma display panel and a plasma display apparatus, and more particularly, to a plasma display panel and plasma display apparatus comprising electrodes.

2. Background of the Related Art

In general, a plasma display panel comprises a front substrate and a rear substrate comprised of soda-lime glass. Barrier ribs formed between the front substrate and the rear substrate partition discharge cells. An inert gas injected into the discharge cells, such as helium-xeon (He—Xe) or helium-neon (He—Ne), is excited with a high frequency voltage to generate a discharge. When the discharge is generated, vacuum ultraviolet rays are generated. Vacuum ultraviolet rays excite phosphors formed between the barrier ribs, thus displaying images.

FIG. 1 is a perspective view schematically showing the construction of a conventional plasma display panel. As shown in FIG. 1, the conventional plasma display panel comprises a front panel and a rear panel. The front panel comprises a front glass substrate 10 and the rear panel comprises a rear glass substrate 20. The front panel and the rear panel are parallel to each other with a predetermined distance therebetween.

On the front glass substrate 10 is formed a sustain electrode pair 11, 12 for sustaining the emission of a cell through mutual discharge. The sustain electrode pair comprises the scan electrode 11 and the sustain electrode 12. The scan electrode 11 comprises a transparent electrode 11a formed of a transparent ITO material and a bus electrode 11b formed of a metal material. The sustain electrode 12 comprises a transparent electrode 12a formed of a transparent ITO material and a bus electrode 12b formed of a metal material.

The scan electrode 11 receives a scan signal for scanning a panel and a sustain signal for sustaining a discharge. The sustain electrode 12 mainly receives a sustain signal. A dielectric layer 13a is formed on the sustain electrode pair 11, 12, and it functions to limit the discharge current and provides insulation between the electrode pairs. A protection layer 14 is formed on a top surface of the dielectric layer 13a and is formed of magnesium oxide (MgO) so as to facilitate a discharge condition.

On the rear glass substrate 20 are disposed address electrodes 22 crossing the sustain electrode pair 11, 12. A dielectric layer 13b is formed on the address electrodes 22 and functions to provide insulation between the address electrodes 22. Barrier ribs 21 are formed on the dielectric layer 13b and partition discharge cells. R, G and B phosphor layer 23 are coated between the barrier ribs 21 and the barrier ribs 21 and radiate a visible ray for displaying images.

The front glass substrate 10 and the rear glass substrate 20 are adhered together by a sealing material. An inert gas, such as helium (He), neon (Ne) or xeon (Xe), is injected into the plasma display panel on which an exhaust process has been performed.

The conventional plasma display panel has a high manufacturing cost since it comprises expensive transparent electrodes 11a, 12a. To prevent an increase of the manufacturing cost, a fence type electrode structure consisting of only the bus electrodes 11b, 12b has been proposed.

FIG. 2 is a plan view of a discharge cell having a fence type electrode structure of the conventional plasma display panel.

As shown in FIG. 2, a plurality of scan bus electrodes 210 and a plurality of sustain bus electrodes 220 are formed on upper and lower sides of a discharge cells instead of obviating expensive transparent electrodes. A scan connection electrode 230 connecting the plurality of scan bus electrodes 210 and a sustain connection electrode 240 connecting the plurality of sustain bus electrodes 220 are also formed in the cell.

The scan bus electrodes 210 connected by the scan connection electrode 230 and the sustain bus electrodes 220 connected by the sustain connection electrode 240 are spaced apart from each other at a predetermined distance, forming a discharge gap 250.

In the conventional fence type electrode structure, a discharge is made possible even without expensive transparent electrodes, but is performed through opaque bus electrodes. Therefore, a problem arises because the aspect ratio is lowered. In addition, since these opaque bus electrodes are all formed within the discharge spaces, the aspect ratio is further lowered.

In the conventional fence type electrode structure, an area in which discharge spaces and bus electrodes are overlapped with each other is smaller than an area in which the discharge spaces and transparent electrodes are overlapped with each other. Therefore, a problem arises because discharge diffusion is poor.

In the conventional fence type electrode structure, the aspect ratio is low and discharge diffusion is poor. Therefore, there are problems in that the brightness and discharge efficiency of the plasma display panel are low.

### SUMMARY OF THE INVENTION

Accordingly, the present invention has been made in view of the above problems occurring in the prior, and it is an object of the present invention to provide a plasma display panel in which a discharge can be generated only using bus electrodes and the aspect ratio can be secured.

It is another object of the present invention to provide a plasma display panel in which a discharge can be generated only using bus electrodes and discharge diffusion can be facilitated.

It is further another object of the present invention to provide a plasma display panel in which a discharge can be generated only using bus electrodes and brightness and discharge efficiency can be enhanced.

To achieve the above objects, a plasma display panel according to the present invention comprises discharge cells partitioned by barrier ribs, upper electrode part and lower electrode part formed adjacent to the boundary of the discharge cells and applied with a first driving pulse, first center electrode part located between the upper electrode part and the lower electrode part and applied with a second driving pulse, and second center electrode part located between the first center electrode part and the lower electrode part and applied with the second driving pulse.

The upper electrode part and the lower electrode part perform the function of scan electrodes. The first center electrode part and the second center electrode part perform the function of sustain electrodes.

The upper electrode part and the lower electrode part perform the function of sustain electrodes. The first center electrode part and the second center electrode part perform the function of scan electrodes.

A width of the upper electrode part is equal to or more than 30 μm to less than or equal to 60 μm, and a width of the lower electrode part is equal to or more than 30 μm to less than or equal to 60 μm.

The upper electrode part and the lower electrode part comprises only bus electrodes.

A width of the first center electrode part is equal to or more than 30 μm to less than or equal to 60 μm, and a width of the second center electrode part is equal to or more than 30 μm to less than or equal to 60 μm.

The first center electrode part and the second center electrode part comprises only bus electrodes.

Each of the upper electrode part and the lower electrode part comprises a plurality of bus electrodes.

Each of the first center electrode part and the second center electrode part comprises only a plurality of bus electrodes.

The first center electrode part and the second center electrode part are separated from each other.

A plasma display panel according to the present invention comprises discharge cells partitioned by barrier ribs, upper electrode part and lower electrode part formed adjacent to the boundary of the discharge cells and applied with a first driving pulse, wherein each of upper electrode part and lower electrode part comprises a first protruding electrode part having one or more protruding electrodes that protrude toward the boundary of the discharge cells, first center electrode part located between the upper electrode part and the lower electrode part and applied with a second driving pulse, the first center electrode part comprising a first protruding electrode part having one or more protruding electrodes that protrude toward the center of the discharge cells, and second center electrode part located between the first center electrode part and the lower electrode part and applied with the second driving pulse, the second center electrode part comprising second protruding electrode part having one or more protruding electrodes that protrude toward the center of the discharge cells.

A width of each of the protruding electrodes comprised in the first protruding electrode part is equal to or more than 100 μm to less than or equal to 250 μm.

A width of each of one or more protruding electrodes comprised in the second protruding electrode part is equal to or more than 100 μm to less than or equal to 250 μm.

The second protruding electrode part of the first center electrode part and the second protruding electrode part of the second center electrode part are separated from each other.

A minimum distance between the protruding electrodes comprised in the second protruding electrode part of the first center electrode part and the protruding electrodes comprised in the second protruding electrode part of the second center electrode part is equal to or more than 50 μm to less than or equal to 200 μm.

Each of the upper electrode part, the lower electrode part, the first center electrode part and the second center electrode part comprises only a bus electrode.

Each of the first protruding electrode part comprises an n number (where, n is an odd number greater than 3) of protruding electrodes. The length of a protruding electrode located at the center, of the n number of the protruding electrodes, ranges from 100% to 200% of that of one of the remaining protruding electrodes.

Each of the first protruding electrode part comprises an n number (where, n is an odd number greater than 3) of protruding electrodes. The length of a protruding electrode located at the center, of the n number of the protruding electrodes, is equal to or more than 100 μm to less than or equal to 250 μm.

Each of the second protruding electrode part comprises an M number (where, M is an odd number greater than 3) of protruding electrodes. The length of a protruding electrode located at the center, of the M number of the protruding electrodes, ranges 100% to 200% of that of one of the remaining protruding electrodes.

Each of the second protruding electrode part comprises an M number (where, M is an odd number greater than 3) of protruding electrodes. The length of a protruding electrode located at the center, of the M number of the protruding electrodes, is equal to or more than 100 μm to less than or equal to 250 μm.

A plasma display apparatus according to the present invention comprises discharge cells partitioned by barrier ribs, a first driving part that applies a first driving pulse, a second driving part that applies a second driving pulse, upper electrode part and lower electrode part formed adjacent to the boundary of the discharge cells and applied with the first driving pulse, first center electrode part located between the upper electrode part and the lower electrode part and applied with the second driving pulse, and second center electrode part located between the first center electrode part and the lower electrode part and applied with the second driving pulse.

The first driving part controls the upper electrode part and the lower electrode part to serve as scan electrodes. The second driving part controls the first center electrode part and the second center electrode part to serve as sustain electrodes.

The first driving part controls the upper electrode part and the lower electrode part to serve as sustain electrodes. The second driving part controls the first center electrode part and the second center electrode part to serve as scan electrodes.

The first center electrode part and the second center electrode part are separated from each other.

Each of the upper electrode part and the lower electrode part comprises first protruding electrode part protruding toward the boundary of the discharge cells. The first protruding electrode part comprises one or more protruding electrodes.

Each of the first center electrode part and the second center electrode part comprises second protruding electrode part protruding toward the center of the discharge cells. The second protruding electrode part comprises one or more protruding electrodes.

The second protruding electrode part comprised in the first center electrode part and the second protruding electrode part comprised in the second center electrode part are separated from each other.

### BRIEF DESCRIPTION OF THE DRAWINGS

Further objects and advantages of the invention can be more fully understood from the following detailed description taken in conjunction with the accompanying drawings in which:

FIG. 1 is a perspective view schematically showing the construction of a conventional plasma display panel;

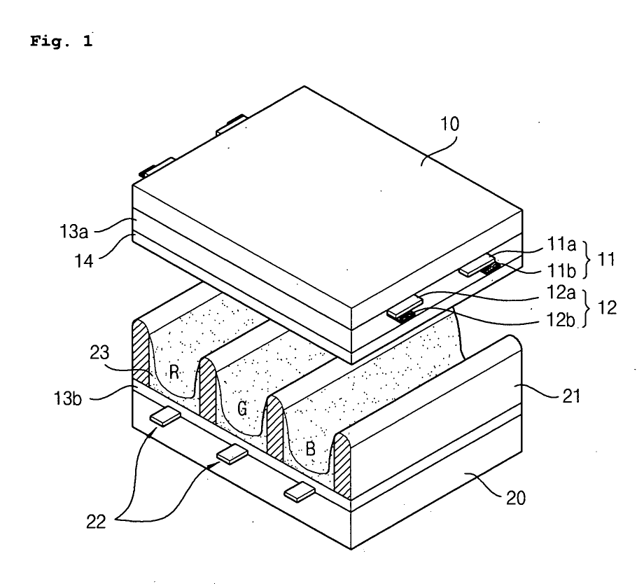

FIG. 2 is a plan view of a discharge cell having a fence type electrode structure of the conventional plasma display panel;

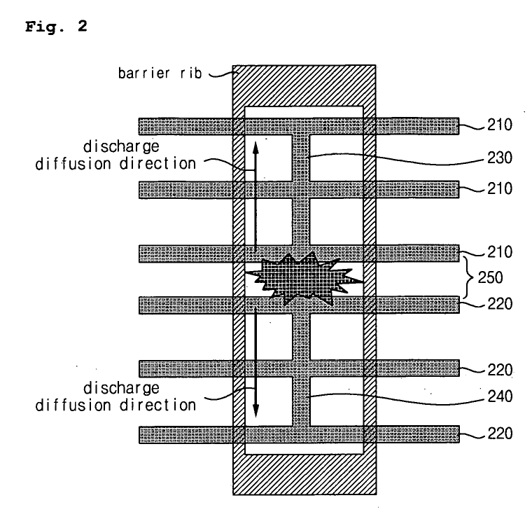

FIG. 3 is a plan view of a plasma display panel according to an embodiment of the present invention;

FIG. 4 is a plan view of a plasma display panel according to another embodiment of the present invention; and

FIG. 5 shows the construction of a plasma display apparatus according to the present invention.

### DETAILED DESCRIPTION OF THE PREFERRED EMBODIMENT

The present invention will now be described in detail in connection with preferred embodiments with reference to the accompanying drawings.

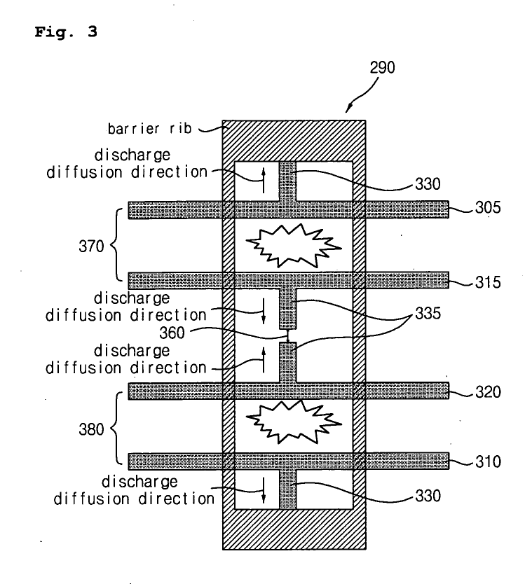

FIG. 3 is a plan view of a plasma display panel according to an embodiment of the present invention. As shown in FIG. 3, the plasma display panel according to the present invention comprises a discharge cell 290, an upper electrode part 305, a lower electrode part 310, a first center electrode part 315 and a second center electrode part 32.0.

The discharge cell 290 is partitioned by a barrier rib 300 and provides a space in which a discharge is generated by an inert gas therein.

The upper electrode part 305 and the lower electrode part 310 are formed adjacent to the boundary of the discharge cell 290, and are applied with a first driving pulse. The upper electrode part 305 and the lower electrode part 310 serve as one of scan electrodes and sustain electrodes. Therefore, if the upper electrode part 305 and the lower electrode part 310 serve as the scan electrodes, the first driving pulse can be a reset pulse, a scan pulse, a sustain pulse and the like, which are input to the scan electrodes. Meanwhile, if the upper electrode part 305 and the lower electrode part 310 serve as the sustain electrodes, the first driving pulse can be a sustain pulse, etc. which is input to the sustain electrodes. A width of each of the upper electrode part 305 or the lower electrode part 310 can be equal to or more than 30 μm to less than or equal to 60 μm.

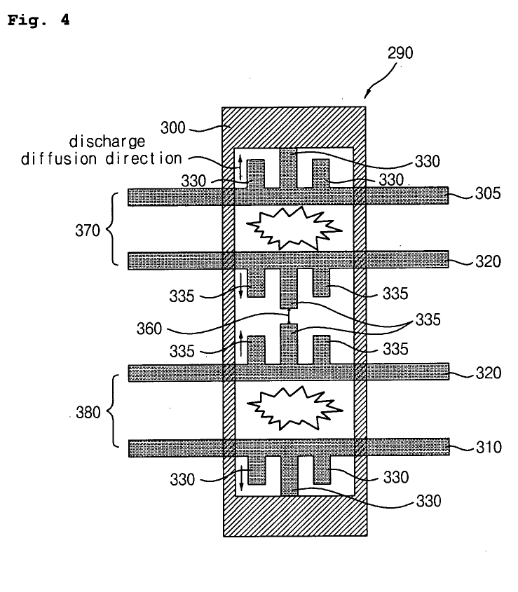

The upper electrode part 305 and the lower electrode part 310 comprise only the bus electrodes. It has been shown in FIG. 3 that the upper electrode part 305 and the lower electrode part 310 comprise only one bus electrode. However, the upper electrode part 305 and the lower electrode part 310 can comprise a plurality of bus electrodes. Each of the upper electrode part 305 and the lower electrode part 310 comprises a first protruding electrode part 330 that protrudes toward the boundary of an adjacent discharge cell. The first protruding electrode part 330 of each of the upper electrode part 305 and the lower electrode part 310 comprises one or more protruding electrodes. The first protruding electrode part 330 shown in FIG. 3 comprises one protruding electrode, and the first protruding electrode part 330 shown in FIG. 4 comprises a plurality of protruding electrodes.

The first protruding electrode part 330 protruding from the upper electrode part 305 is protruded toward an upper boundary region direction of a discharge cell adjacent to the upper electrode part 305. The first protruding electrode part 330 protruding from the lower electrode part 310 is protruded toward a lower boundary region direction of a discharge cell adjacent to the lower electrode part 310. A width of the protruding electrodes comprised in the first protruding electrode part 330, respectively, can be equal to or more than 100 μm to less than or equal to 250 μm.

As shown in FIG. 4, the first protruding electrode part 330 can comprises an n number (where, n is an odd number greater than 3) of protruding electrodes. The length of a center protruding electrode located at the center of the n number of the protruding electrodes is 100% to 200% of that of one of the remaining peripheral protruding electrodes. In addition, the length of the center protruding electrode comprised in the first protruding electrode part 330 can be equal to or more than 100 μm to less than or equal to 250 μm.

The first center electrode part 315 is located between the upper electrode part 305 and the lower electrode part 310, and is applied with a second driving pulse. The first center electrode part 315 forms a first discharge gap 370 corresponding to the upper electrode part 305. That is, if the upper electrode part 305 serves the scan electrode, the first center electrode part 315 receives the second driving pulse, such as a sustain pulse, in order to perform the function of the sustain electrode. Meanwhile, if the upper electrode part 305 serves as the sustain electrode, the first center electrode part 315 receives the second driving pulse such as a reset pulse, a scan pulse and a sustain pulse in order to perform the function of the scan electrode. A width of the first center electrode part 315 can be equal to or more than 30 μm to less than or equal to 60 μm.

The second center electrode part 320 is located between the first center electrode part 315 and the lower electrode part 310, and is applied with the second driving pulse. The second center electrode part 320 forms a second discharge gap 380 corresponding to the lower electrode part 310. That is, if the lower electrode part 310 serves as the scan electrode, the second center electrode part 320 receives the second driving pulse, such as a sustain pulse, in order to perform the function of the sustain electrode. Meanwhile, if the lower electrode part 310 performs the function of the sustain electrode, the second center electrode part 320 receives the second driving pulse, such as a reset pulse, a scan pulse and a sustain pulse, in order to perform the function of the scan electrodes. A width of the second center electrode part 320 can be equal to or more than 30 μm to less than or equal to 60 μm.

The first center electrode part 315 and the second center electrode part 320 consists only bus electrodes. It has been shown in FIG. 3 that each of the first center electrode part 315 and the second center electrode part 320 comprises only one bus electrode. However, each of the first center electrode part 315 and the second center electrode part 320 can comprise a plurality of bus electrodes.

Each of the first center electrode part 315 and the second center electrode part 320 comprises a second protruding electrode part 335 that protrudes toward the center of the discharge cell 290. The second protruding electrode part 335 of each of the first center electrode part 315 and the second center electrode part 320 comprises one or more protruding electrodes. The second protruding electrode part 335 shown in FIG. 3 comprises one protruding electrode, and the second protruding electrode part 335 shown in FIG. 4 comprises a plurality of protruding electrodes. The second protruding electrode part 335 protruding from the first center electrode part 315 and the second protruding electrode part 335 protruding from the second center electrode part 320 are opposite to each other.

A width of the protruding electrode comprised in the second protruding electrode part 335 can be equal to or more than 100 μm to less than or equal to 250 μm. As shown in FIG. 4, the center protruding electrode of the second protruding electrode part 335 comprises an M number (where, M is an odd number greater than 3) of protruding electrodes. The length of a center protruding electrode located at the center of the M number of the protruding electrodes can range from 100% to 200% of that of one of the remaining peripheral protruding electrodes. In addition, the length of the center protruding electrode of the second protruding electrode part 335 can is equal to or more than 100 μm to less than or equal to 250 μm.

Discharge diffusion by a plurality of protruding electrodes shown in FIG. 4 is smoothly performed compared with discharge diffusion by one protruding electrode shown in FIG. 3.

This discharge process in the plasma display panel of the present invention will be described below in detail.

It is first assumed that a sustain discharge for emission is generated in the discharge cell of the plasma display panel according to the present invention, the upper electrode part 305 and the lower electrode part 310 perform the function of the scan electrode, and the first center electrode part 315 and the second center electrode part 320 perform the function of the sustain electrode.

The upper electrode part 305 and the lower electrode part 310 are applied with the sustain pulse, i.e., the first driving pulse at the same time. The first center electrode part 315 and the second center electrode part 320 are then applied with the sustain pulse, which alternates with the first driving pulse, at the same time.

Therefore, a sustain discharge is generated between the first discharge gap 370 formed between the upper electrode part 305 and the first center electrode part 315. A sustain discharge is generated in the second discharge gap 380 formed between the lower electrode part 310 and the second center electrode part 320.

That is, in the plasma display panel comprising electrodes having the conventional fence structure, one discharge gap is formed in one discharge cell. In the plasma display panel of the present invention, however, two discharge gaps are formed in one discharge cell. Therefore, the present invention can increase brightness and discharge efficiency while accomplishing the aspect ratio by maximum.

The sustain discharge generated in the first discharge gap 370 is diffused into the boundary direction of the discharge cell 290 by means of the first protruding electrode part 330 provided in the upper electrode part 305, and is also diffused into the center direction of the discharge cell 290 by means of the second protruding electrode part 335 provided in the first center electrode part 315.

Furthermore, the sustain discharge generated in the second discharge gap 380 is diffused into the boundary direction of the discharge cell 290 by means of the first protruding electrode part 330 provided in the lower electrode part 310, and is also diffused into the center direction of the discharge cell 290 by means of the second protruding electrode part 335 provided in the second center electrode part 320.

Therefore, the sustain discharges generated in the first discharge gap 370 and the second discharge gap 380 are diffused into the entire region within the discharge cell 290. That is, in the fence type electrodes comprised in the conventional plasma display panel, since an area in which the electrodes and discharge spaces are overlapped with each other is small, discharge diffusion was poor. In electrodes comprised in the plasma display panel according to the present invention, however, the discharges generated in the two discharge gaps 370,380 are diffused into the entire region within the discharge cell 290. Therefore, the plasma display panel of the present invention can improve brightness and discharge efficiency.

Furthermore, in the case where the plurality of protruding electrodes is formed as shown in FIG. 4, the area of the bus electrodes can be widened. Therefore, a sufficient amount of wall charges can be accumulated and discharge diffusion can be performed more smoothly. As a result, a discharge sustain voltage can be lowered and a strong discharge can be generated.

The first center electrode part 315 and the second center electrode part 320 comprised in the plasma display panel constructed above according to the present invention can be preferably separated from each other.

In the case where the first center electrode part 315 and the second center electrode part 320 are connected to each other, if a discharge is first generated in one of two discharge gaps due to a characteristic of a plasma display panel, spreading of wall charges, etc., the wall charges move toward a surface of electrodes forming the other of the two discharge gaps due to the firstly generated discharge, and hinder a discharge that is generated in the other of the discharge gaps.

For this reason, the second protruding electrode part 335 comprised in the first center electrode part 315 and the second protruding electrode part 335 comprised in the second center electrode part 320 can be preferably spaced apart from each other. A minimum distance 360 between protruding electrodes comprised in the second protruding electrode part 335 of the first center electrode part 315 and protruding electrodes comprised in the second protruding electrode part 335 of the second center electrode part 320 can be preferably equal to or more than 50 μm to less than or equal to 200 μm.

A plasma display apparatus according to the present invention will be described in detail with reference to the accompanying drawings.

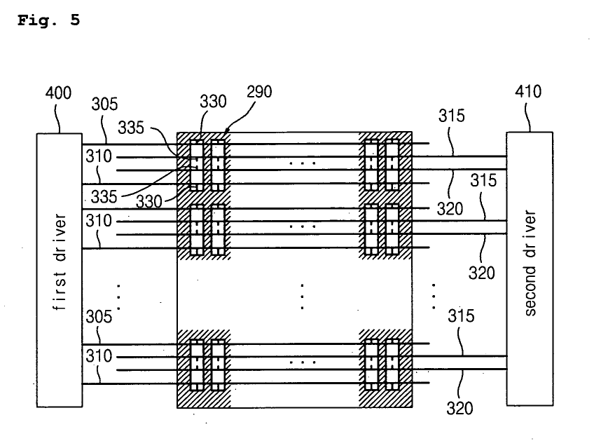

FIG. 5 shows the construction of a plasma display apparatus according to the present invention.

As shown in FIG. 5, the plasma display apparatus according to the present invention comprises discharge cells 290, upper electrode part 305, lower electrode part 310, first center electrode part 315, second center electrode part 320, a first driving part 400 and a second driving part 410.

The discharge cells 290 are partitioned by barrier ribs 300 and provide spaces in which a discharge is generated by an inert gas therein.

The upper electrode part 305 and the lower electrode part 310 are formed adjacent to the boundary of the discharge cells 290 and are applied with a first driving pulse from the first driving part 400. A width of the upper electrode part 305 or the lower electrode part 310 can be preferably equal to or more than 30 μm to less than or equal to 60 μm. The upper electrode part 305 and the lower electrode part 310 constructed above comprise only bus electrodes. Each of the upper electrode part 305 and the lower electrode part 310 comprises a first protruding electrode part 330 that protrudes toward the boundary of adjacent discharge cells. The first protruding electrode part 330 of each of the upper electrode part 305 and the lower electrode part 310 comprises one or more protruding electrodes. The first protruding electrode part 330 can comprise one protruding electrode, as shown in FIG. 3, and can comprise a plurality of protruding electrodes, as shown in FIG. 4.

The first protruding electrode part 330 protruding from the upper electrode part 305 protrude in an upper boundary region direction of a discharge cell adjacent to the upper electrode part 305. The first protruding electrode part 330 protruding from the lower electrode part 310 protrude in a lower boundary region direction of a discharge cell adjacent to the lower electrode part 310. A width of each of the protruding electrodes comprised in the first protruding electrode part 330 can be preferably equal to or more than 100 μm to less than or equal to 250 μm.

The first center electrode part 315 is located between the upper electrode part 305 and the lower electrode part 310 and is applied with a second driving pulse from the second driving part 410. The first center electrode part 315 form the first discharge gap 370 corresponding to the upper electrode part 305. A width of the first center electrode part 315 can be preferably equal to or more than 30 μm to less than or equal to 60 μm.

The second center electrode part 320 are located between the first center electrode part 315 and the lower electrode part 310 and are applied with the second driving pulse from the second driving part 410. The second center electrode part 320 forms the second discharge gap 380 corresponding to the lower electrode part 310. A width of the second center electrode part 320 can be preferably equal to or more than 30 μm to less than or equal to 60 μm.

The first center electrode part 315 and the second center electrode part 320 comprised in the plasma display apparatus of the present invention can be preferably separated from each other. Furthermore, the second protruding electrode part 335 comprised in the first center electrode part 315 and the second protruding electrode part 335 comprised in the second center electrode part 320 can also be preferably separated from each other. The second protruding electrode part 335 comprises one or more protruding electrodes.

The second protruding electrode part 335 can comprise one protruding electrode, as shown in FIG. 3, and the second protruding electrode part 335 can comprise a plurality of protruding electrodes, as shown in FIG. 4. A width of each of the protruding electrodes comprised in the second protruding electrode part 335 can be preferably equal to or more than 100 μm to less than or equal to 250 μm. In addition, the minimum distance 360 between the protruding electrodes comprised in the second protruding electrode part 335 of the first center electrode part 315 and the protruding electrodes comprised in the second protruding electrode part 335 of the second center electrode part 320 can be preferably equal to or more than 50 μm to less than or equal to 200 μm.

The first driving part 400 applies the first driving pulse to the upper electrode part 305 and the lower electrode part 310.

The second driving part 410 applies the second driving pulse to the first center electrode part 315 and the second center electrode part 320.

If the first driving part 400 applies the first driving pulse such as a reset pulse, a scan pulse or a sustain pulse to the upper electrode part 305 and the lower electrode part 310, the second driving part 410 applies the second driving pulse, such as a sustain pulse, to the first center electrode part 315 and the second center electrode part 320. Therefore, the upper electrode part 305 and the lower electrode part 310 perform the function of the scan electrode and the first center electrode part 315 and the second center electrode part 320 perform the function of the sustain electrode.

Furthermore, if the first driving part 400 applies the first driving pulse, such as the sustain pulse, to the upper electrode part 305 and the lower electrode part 310, the second driving part 410 applies the second driving pulse, such as the reset pulse, the scan pulse or the sustain pulse, to the first center electrode part 315 and the second center electrode part 320. Therefore, the upper electrode part 305 and the lower electrode part 310 perform the function of the sustain electrode and the first center electrode part 315 and the second center electrode part 320 perform the function of the scan electrode.

As described above, according to the present invention, since a plurality of discharge gaps and protruding electrodes are formed, the aspect ratio can be secured, a discharge amount can be increased and discharge diffusion can be smoothly performed. Therefore, the present invention is advantageous in that it can improve brightness and discharge efficiency since a discharge amount is increased and discharge diffusion is easily performed.

The invention being thus described, it will be obvious that the same may be varied in many ways. Such variations are not to be regarded as a departure from the spirit and scope of the invention, and all such modifications as would be obvious to one skilled in the art are intended to be comprised within the scope of the following claims.

What is claimed is:

1. A plasma display panel, comprising:
a discharge cell partitioned by barrier ribs;
an upper electrode part and an lower electrode part formed adjacent to the boundary of the discharge cell, and applied with a first driving pulse;
a first center electrode part located between the upper electrode part and the lower electrode part, and applied with a second driving pulse; and
a second center electrode part located between the first center electrode part and the lower electrode part and applied with the second driving pulse.

2. The plasma display panel as claimed in claim 1, wherein the upper electrode part and the lower electrode part serve as a scan electrode, and
the first center electrode part and the second center electrode part serve as a sustain electrode.

3. The plasma display panel as claimed in claim 1, wherein the upper electrode part and the lower electrode part serve as a sustain electrode, and
the first center electrode part and the second center electrode part serve as a scan electrode.

4. The plasma display panel as claimed in claim 1, wherein a width of the upper electrode part is equal to or more than 30 μm to less than or equal to 60 μm, and a width of the lower electrode part is equal to or more than 30 μm to less than or equal to 60 μm.

5. The plasma display panel as claimed in claim 1, wherein each of the upper electrode part and the lower electrode part comprises only bus electrodes.

6. The plasma display panel as claimed in claim 1, wherein a width of the first center electrode part is equal to or more than 30 μm to less than or equal to 60 μm, and a width of the second center electrode part is equal to or more than 30 μm to less than or equal to 60 μm.

7. The plasma display panel as claimed in claim 1, wherein each of the first center electrode part and the second center electrode part comprises only bus electrodes.

8. The plasma display panel as claimed in claim 1, wherein each of the upper electrode part and the lower electrode part comprises a plurality of bus electrodes.

9. The plasma display panel as claimed in claim 1, wherein each of the first center electrode part and the second center electrode part comprises only a plurality of bus electrodes.

10. The plasma display panel as claimed in claim 1, wherein the first center electrode part and the second center electrode part are separated from each other.

11. A plasma display panel, comprising:
a discharge cell partitioned by barrier ribs;
an upper electrode part and a lower electrode part formed adjacent to the boundary of the discharge cell and applied with a first driving pulse, wherein each of upper electrode part and lower electrode part comprises a first protruding electrode part having one or more protruding electrodes that protrude toward the boundary of the discharge cell;
a first center electrode part located between the upper electrode part and the lower electrode part and applied with a second driving pulse, the first center electrode part comprising first protruding electrode part having one or more protruding electrodes that protrude toward the center of the discharge cell; and
a second center electrode part located between the first center electrode part and the lower electrode part and applied with the second driving pulse, the second center electrode part comprising second protruding electrode part having one or more protruding electrodes that protrude toward the center of the discharge cell.

12. The plasma display panel as claimed in claim 11, wherein a width of each of the protruding electrodes comprised in the first protruding electrode part is equal to or more than 100 μm to less than or equal to 250 μm.

13. The plasma display panel as claimed in claim 11, wherein a width of each of one or more protruding electrodes comprised in the second protruding electrode part is equal to or more than 100 μm to less than or equal to 250 μm.

14. The plasma display panel as claimed in claim 11, wherein the second protruding electrode part of the first center electrode part and the second protruding electrode part of the second center electrode part are separated from each other.

15. The plasma display panel as claimed in claim 14, wherein a minimum distance between the protruding electrodes comprised in the second protruding electrode part of the first center electrode part and the protruding electrodes comprised in the second protruding electrode part of the second center electrode part is equal to or more than 50 μm to less than or equal to 200 μm.

16. The plasma display panel as claimed in claim 11, wherein each of the upper electrode part, the lower electrode part, the first center electrode part and the second center electrode part comprises only bus electrodes.

17. The plasma display panel as claimed in claim 11, wherein each of the first protruding electrode part comprises an n number (where, n is an odd number greater than 3) of protruding electrodes, and
the length of a protruding electrode located at the center, of the n number of the protruding electrodes, ranges from 100% to 200% of that of one of the remaining protruding electrodes.

18. The plasma display panel as claimed in claim 11, wherein each of the first protruding electrode part comprises an n-number (where, n is an odd number greater than 3) of protruding electrodes, and
the length of a protruding electrode located at the center, of the n number of the protruding electrodes, is equal to or more than 100 μm to less than or equal to 250 μm.

19. The plasma display panel as claimed in claim 11, wherein each of the second protruding electrode part comprises an M number (where, M is an odd number greater than 3) of protruding electrodes, and
the length of a protruding electrode located at the center, of the M number of the protruding electrodes, ranges from 100% to 200% of that of one of the remaining protruding electrodes.

20. The plasma display panel as claimed in claim 11, wherein each of the second protruding electrode part comprises an M number (where, M is an odd number greater than 3) of protruding electrodes, and
the length of a protruding electrode located at the center, of the M number of the protruding electrodes, is equal to or more than 100 μm to less than or equal to 250 μm.

21. A plasma display apparatus, comprising:
discharge cell partitioned by barrier ribs;
a first driving part that applies a first driving pulse;
a second driving part that applies a second driving pulse;
upper electrode part and lower electrode part formed adjacent to the boundary of the discharge cell and applied with the first driving pulse;
first center electrode part located between the upper electrode part and the lower electrode part and applied with the second driving pulse; and
second center electrode part located between the first center electrode part and the lower electrode part and applied with the second driving pulse.

22. The plasma display apparatus as claimed in claim 21, wherein the first driving part controls the upper electrode part and the lower electrode part to serve as scan electrodes, and
the second driving part controls the first center electrode part and the second center electrode part to serve as sustain electrodes.

23. The plasma display apparatus as claimed in claim 21, wherein the first driving part controls the upper electrode part and the lower electrode part to serve as sustain electrodes, and
the second driving part controls the first center electrode part and the second center electrode part to serve as scan electrodes.

24. The plasma display apparatus as claimed in claim 21, wherein the first center electrode part and the second center electrode part are separated from each other.

25. The plasma display apparatus as claimed in claim 21, wherein each of the upper electrode part and the lower electrode part comprises first protruding electrode part protruding toward the boundary of the discharge cell, and
the first protruding electrode part comprises one or more protruding electrodes.

26. The plasma display apparatus as claimed in claim 21, wherein each of the first center electrode part and the second center electrode part comprises second protruding electrode part protruding toward the center of the discharge cell, and
the second protruding electrode part comprises one or more protruding electrodes.

27. The plasma display apparatus as claimed in claim 26, wherein the second protruding electrode part comprised in the first center electrode part and the second protruding electrode part comprised in the second center electrode part are separated from each other.
